(19) United States
(12) Patent Application Publication
(10) Pub. No.: US 2004/0116263 A1
(43) Pub. Date: Jun. 17, 2004

(54) Material dispenser

(76) Inventor: Stefan Thierfelder, Hilpoltstein (DE)

Correspondence Address: LERNER AND GREENBERG, PA, P O BOX 2480, HOLLYWOOD, FL, 33022-2480, US

(21) Appl. No.: 10/650,819

(22) Filed: Aug. 28, 2003

(30) Foreign Application Priority Data
Sep. 2, 2002 (DE) 102 40 375.9

(51) Int. Cl. B25F 5/02

(52) U.S. Cl. 492/40; 492/47; 29/895.22

(57) ABSTRACT

The invention relates to a material dispenser. For particularly efficient packaging, the invention proposes a material dispenser (1) having a first roller (2) for a web material, in particular for a web-like packaging material, and having at least one second roller (3, 6) for a binding material, in particular for a string-like, strip-like or ribbon-like binding material, the rollers being connected to one another by at least one connecting element (7, 15).

The invention relates to a material dispenser.

Material dispensers in the case of which a web material, in particular a web-type packaging material, for example giftwrap or wrapping paper, is provided in roll form for packaging purposes are known. Such material dispensers are widely available, inter alia, from retailers, for example in department stores. The web material is used for packaging articles, the packaging usually being tied up, and thus secured, by a binding material, The binding material, for example string or giftwrapping ribbon, is mostly wound up on suitable reels or rollers. For the purpose of packaging an article, web and binding materials have to be unwound from their rollers or reels before the respective article can be packaged.

The object of the invention is to provide a material dispenser which allows particularly efficient packaging. This object is achieved by a material dispenser as claimed in claim 1.

The material dispenser according to the invention has a first roller for a web material, in particular for a web-like packaging material, and at least one second roller for a binding material, in particular for a string-like, strip-like or ribbon-like binding material, the rollers being connected to one another by at least one connecting element.

An essential point of the invention is to connect the material dispensers for web material and binding material, which were previously kept separately at the packaging location, to form an integrated, central unit. The resulting material dispenser unites web-material and binding-material rollers to form a material-dispenser unit which can be combined in any desired manner. This combination avoids unnecessary actions having to be carried out for the purpose of packaging articles. All the material which is required for packaging purposes is made available to the user centrally in a single device. This reduces to a considerable extent the amount of time which is required for packaging purposes, and this gives rise to a particularly efficient packaging operation.

Furthermore, each roller has an accommodating opening. The accommodating opening here may be formed either just in a sub-region of the roller, advantageously at the free ends of the latter, or else such that it passes through the entire roller. It is thus possible for all the rollers to be retained on a common roller mount. In addition, the accommodating opening can be used for producing the connection between the rollers.

The connection between adjacent spaces is produced by a connecting element which has a number of fastening arms. The fastening arms here extend essentially in the longitudinal direction of the rollers and serve for forming a connection to the inner circumference of the adjacent roller. The fastening arms are of resilient design and, in the open position, are positioned outward away from the longitudinal direction of the rollers.

The connecting element, in addition, is configured as a separate component. This allows the material dispenser to be handled in a particular flexible manner.

Web material is understood here, in particular, as packaging material such as packaging paper or packaging foil, preferably particularly configured, for example patterned giftwrap. The web material used, however, may likewise be wrapping paper of very straightforward configuration. In addition to paper and foil materials, for example metal foils or foils with a metal coating, it is, of course, also possible to use textile fiber materials or plastic materials as the web material.

Binding material is understood here, in particular, as string-like, strip-like and ribbon-like binding material. In particular, binding material within the context of the invention comprises woven and non-woven ribbons made of textile fiber materials, plastic films, paper, natural fiber materials, metal foils or combinations of the abovementioned materials. In addition to the ribbons, the term binding material also includes cord, string and the like made of the abovementioned materials and combinations thereof.

Within the context of the invention, a roller is understood as any cylindrical device on which a web material or binding material can be wound up, in particular conventional rollers, for example in the form of a board or plastic tube, reels, cassettes, rings or the like.

In a particular embodiment of the invention, the rollers are connected to one another in a form-fitting manner (claim 2) and/or in a force-fitting manner (claim 3). It is particularly advantageous if the connection between the rollers is releasable (claim 4). The user can then combine the various rollers with one another in any desired manner.

According to the teaching of claim 5, the rollers are connected to one another in the longitudinal direction of the rollers. This ensures particularly straightforward unwinding of the web and binding materials.

Connecting the rollers in the longitudinal direction gives a multiplicity of possible combinations. In the simplest case, the second roller is arranged on one end side of the first roller such that it adjoins the latter in the longitudinal direction of the rollers. It is also possible for a further binding-material roller to be arranged on the second free end side of the first roller, with the result that the web-material roller is flanked on both sides by binding-material rollers. Furthermore, it is possible for a plurality of, for example two or three, binding-material rollers to be connected to one another, with the result that a plurality of binding-material rollers are fitted on a web-material roller. Such a material dispenser with a multiplicity of different binding materials can be used to particularly good effect for giftwrapping.

The connection between the rollers preferably takes place with the formation of a clamping connection (claim 6). This has the advantage that clamping connections are particularly easy to produce and to release again. In addition, the clamping connection may be provided such that the connection can be opened and closed without an additional actuating tool being used. Particularly straightforward handling of the material dispenser is achieved as a result.

For a particularly secure connection between the rollers, the fastening arms have frictional elements at their free ends (claim 7). The fastening arms form a particularly secure frictional/clamping connection with the inner circumference of the adjacent roller if they butt against the latter under prestressing.

The connecting element advantageously has two groups of fastening arms (claim 8), the mutually opposite fastening arms extending in opposite directions.

In the particularly preferred embodiment of the invention as claimed in claim 9, the connecting element has an extension extending in the longitudinal direction of the rollers, such that the extension forms a connection with the inner circumference of an adjacent roller. The extension is advantageously cylindrical, with the result that it is adapted to the inner circumference of the roller which is to be connected. The extension tapers conically in the direction of its free end, with the result that it is formed in the manner of a truncated cone. The extension, furthermore, is formed such that, at at least one location, it has a diameter which corresponds to the internal diameter of the adjacent roller.

With the aid of a connecting element designed in this way, it is possible for adjacent rollers to be connected to one another in a particularly straightforward manner, namely simply by being plugged onto one another. The internal diameter of the web-material and/or binding-material rollers is usually two or three inches. The extension of the connecting element is designed to correspond to this internal diameter. The tapering of the extension also makes it possible for rollers which do not have standard internal diameters to be connected to one another.

The connecting element may have both two extensions and both an extension and a number of fastening arms, the then respectively opposite extensions or fastening arms extending in opposite directions.

The connecting element is preferably connected integrally to a roller. It is particularly advantageous if the connecting element forms an integrated unit together with the web-material roller, with the result that the user can connect any desired second roller to the web-material roller.

The material dispenser according to the invention, designed as a combination dispenser, can be used as an unwinding mechanism on its own or in conjunction with a roller mount (claim 10). The roller mount, preferably designed in framework form, may be configured such that an individual retaining rod passes through all the interconnected rollers, or such that two retaining brackets engage in the end accommodating openings of the roller combination. It is basically possible here for the roller mount to be fitted vertically and horizontally.

The present invention can be used as a table-top, wall-mounted or set-down dispenser and as a vertical dispenser and under-table dispenser or the like.

Further embodiments of the invention can be gathered from the subclaims.

The invention is described hereinbelow with reference to exemplary embodiments, which will be explained in more detail with reference to the figures, in which:

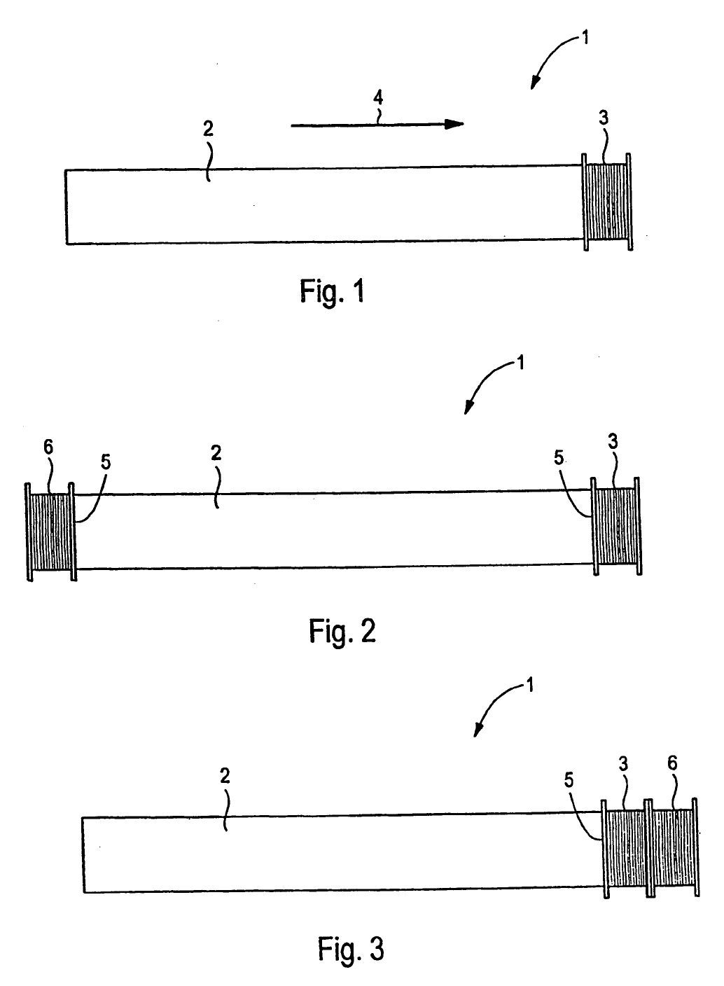

FIG. 1 shows a first embodiment of a material dispenser,

FIG. 2 shows a second embodiment of a material dispenser,

FIG. 3 shows a third embodiment of the material dispenser,

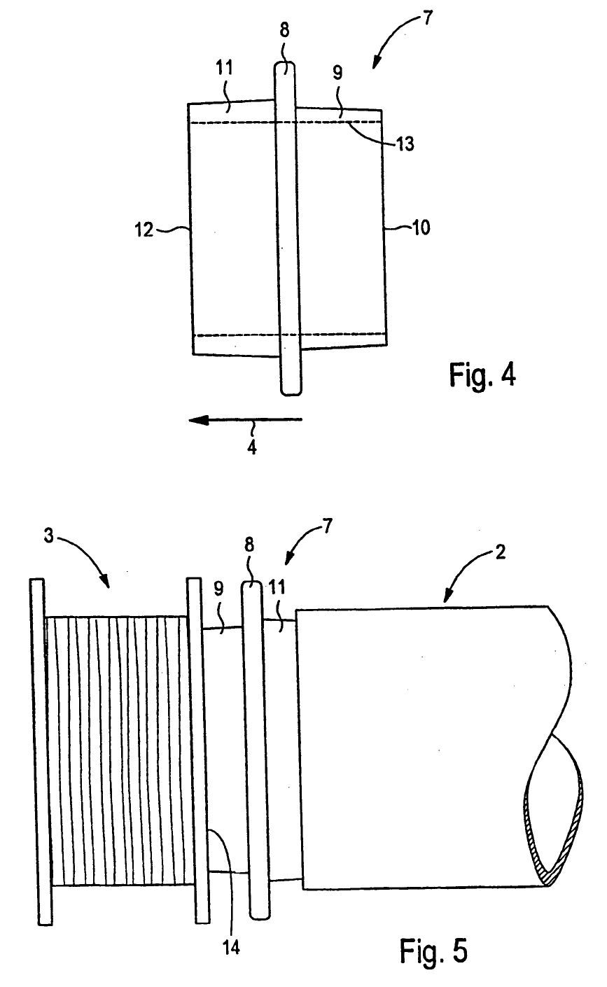

FIG. 4 shows a first connecting element,

FIG. 5 shows a material dispenser with a first connecting element, and

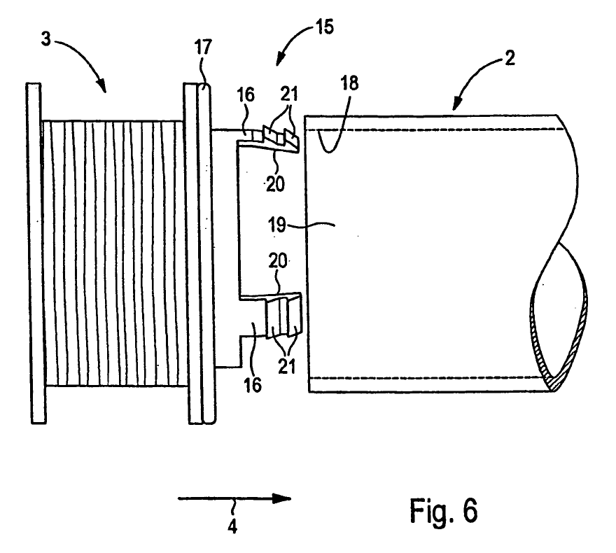

FIG. 6 shows a material dispenser with a second connecting element.

FIG. 1 shows a material dispenser 1 according to the invention having a first roller 2, on which is wound a giftwrap web for packaging an article. A second roller 3 in the form of a reel for a giftwrapping ribbon is arranged on the first roller 2. The two rollers 2, 3 here are connected to one another in the longitudinal direction 4 of the rollers and are arranged in relation to one another such that they can be retained on a common axis by means of a roller mount (not depicted).

FIG. 2 shows a further exemplary embodiment of the invention, in which in each case one second roller is fitted on the two end sides 5 of the giftwrap roller 2, this resulting in binding-material rollers being arranged on both sides. These rollers are a giftwrapping-ribbon reel 3, which has already been shown in FIG. 1, and a reel 6 with a cord.

FIG. 3 shows a further exemplary embodiment of the invention. The binding-material rollers here, as in FIG. 1, are fitted on one side of the web-material roller 2. In this case, however, a plurality of binding-material rollers 3, 6 are connected directly to one another.

Instead of the binding-material rollers 3, 6 which are depicted in FIGS. 1 to 3, it is, of course, also possible to use narrower or wider rollers bearing binding materials with a respectively smaller or larger width or a smaller or larger diameter. The diameter and the width of the binder materials are usually in a range of from 1 to 100 mm. The binding materials here may be wound onto the second rollers 3, 6 such that each roller has only a single type of binding material. It is likewise possible, however, to use binding-material rollers in the case of which a plurality of different binding materials are wound up at spatial intervals on a single multiple reel.

In order to ensure the connection between the first and second roller, use is made of connecting elements which are connected in a wide variety of different ways to the first roller 2 and/or to the second roller or rollers 3, 6. It is thus possible, for example, for the giftwrapping-ribbon reel 3 or the cord reel 6 to have a single-piece, integral connecting element on one or both end sides. It is likewise possible for a connecting element to be integrally formed on one or both end sides 5 of the web-material roller. Furthermore, it is possible for the connecting element to be configured as a separate component which is arranged in each case between the rollers which are to be connected.

Such a separate component is depicted in FIG. 4. This is an essentially cylindrical connecting element 7 which is designed in the manner of an adapter for the different internal diameters of the rollers 2, 3 which are to be connected. The component may be produced as an injection molding from a plastic material or as a molding foamed from a plastic foam or else as a pressed part made of organic materials and synthetic and natural rubbers.

The connecting element 7, which is constructed in the manner of a tube, has three regions arranged adjacent to one another in the longitudinal direction 4 of the rollers. The central region 8 here is designed as a supporting or spacer region. In the assembled state, it defines the spacing between the adjacent rollers 2, 3. This central region 8 is adjoined, in one longitudinal direction 4 of the rollers, by a first extension 9, which tapers in the direction of its free end 10. In the opposite longitudinal direction 4 of the rollers, the central region 8 is adjoined by a second extension 11. This second extension 11 also tapers in the direction of its free end 12. The two extensions 9, 11 have different diameters. Thus, for example, the first extension 9, starting from the central region 8, tapers in the direction of its free end 10 from 2 inches to 1.8 inches, while the second extension 11 tapers from the central region 8 to the free end 12 from 3 inches to 2.6 inches. A continuous accommodating opening 13 is provided in the interior of the adapter 7 and serves for accommodating a roller mount (not depicted).

FIG. 5 shows the adapter component 7, which has already been described in FIG. 4 and is used for the connection between a giftwrap roller 2 and a giftwrapping-ribbon reel 3. In the final assembled position, the central part 8 of the connecting element 7, said central part projecting beyond the two extensions 9, 11, serves, at the same time, as an abutment for the side wall 14 of the giftwrapping-ribbon reel 3 which is to be connected.

In a second exemplary embodiment, as is illustrated in FIG. 6, use is made of a connecting element 15 with fastening arms 16. The giftwrapping-ribbon reel 3 has already been fully connected to the connecting element 15. This connecting element 15 also has a central part 17, from which three fastening arms 16 extend in the direction of the giftwrap roller 2 which is to be connected. The fastening arms 16 here are spaced apart from one another at equal intervals, with the result that, in the final assembled state, the connecting forces act uniformly on the inner circumference 18 of the giftwrap roller 2. The fastening arms 16 are oriented outward away from the longitudinal direction 4 of the rollers. For the purpose of fastening the giftwrap roller 2 on the connecting element 15, the elastic fastening arms 16 are forced in the direction of the roller axis and introduced into the accommodating opening 19 of the giftwrap roller 2. There, they then butt against the inner circumference 18 under prestressing. Fitted at the free ends 20 of the fastening arms 16 are frictional elements 21 in the form of in each case three latching tongues which run transversely to the longitudinal direction 4 of the rollers and, when the resilient fastening arms 16 expand, enhance the contact with the inner circumference 18.

It can be left open, in the case of that exemplary embodiment of the invention which is shown in FIG. 6, as to whether the connecting element 15 has only this one group of fastening arms 16, and has its opposite side integrally formed on the giftwrapping-ribbon reel 3, or whether the connecting element 15 is a separate component in the case of which the connection to the giftwrapping-ribbon reel 3 takes place by means of a second group of fastening arms or else by means of an extension as is known from FIGS. 4 and 5.

1. A material dispenser (1)
having a first roller (2) for a web material, in particular for a web-like packaging material,
having at least one second roller (3, 6) for a binding material, in particular for a string-like, strip-like or ribbon-like binding material, and
having at least one connecting element (15) for connecting the rollers to one another,
characterized in that each roller (2, 3, 6) has at least one accommodating opening (19) for accommodating the connecting element (15) and/or a roller mount, and in that the connecting element is configured as a separate component and has a number of resilient fastening arms (16) which extend essentially in the longitudinal direction (4) of the rollers and are intended for forming a connection to the inner circumference (18) of an adjacent roller, the fastening arms (16), in the open position, being positioned radially outward such that their free ends (20) are arranged over a circle of which the diameter is larger than the internal diameter of the roller which is connected to the fastening arms (16).

2. The material dispenser (1) as claimed in claim 1, characterized by a form-fitting connection between the rollers (2, 3, 6).

3. The material dispenser (1) as claimed in claim 1 or 2, characterized by a force-fitting connection between the rollers (2, 3, 6).

4. The material dispenser (1) as claimed in one of claims 1 to 3, characterized in that the rollers (2, 3, 6) are connected to one another in a releasable manner.

5. The material dispenser (1) as claimed in one of claims 1 to 4, characterized in that the rollers (2, 3, 6) are connected to one another in the longitudinal direction (4) of the rollers.

6. The material dispenser (1) as claimed in one of claims 1 to 5, characterized in that the connecting element (15) forms a wedge connection or clamping connection between the rollers (2, 3, 6).

7. The material dispenser (1) as claimed in one of claims 1 to 6, characterized in that, at their free ends (20), the fastening arms (16) have frictional elements (21) for forming a friction fit with the inner circumference (18) of an adjacent roller.

8. The material dispenser (1) as claimed in one of claims 1 to 7, characterized in that the connecting element (15) has two groups of fastening arms (16), of which the free ends (20) are oriented in opposite directions.

9. The material dispenser (1) as claimed in one of claims 1 to 7, characterized in that the connecting element (15) has both a number of fastening arms (16) and an extension (9, 11), extending in the longitudinal direction (4) of the rollers, for forming a connection to the inner circumference (18) of an adjacent roller, the free ends (10, 20) of fastening arms (16) and extension (9, 11) being oriented in opposite directions, and the extension (9, 11) tapering conically in the direction of its free end (10, 12) such that, at at least one location, it has a diameter which corresponds to the internal diameter of the roller which is connected to the extension (9, 11).

10. The material dispenser (1) as claimed in one of claims 1 to 9, characterized by a roller mount which retains the rollers (2, 3, 6).
